(19) United States
(12) Patent Application Publication
(10) Pub. No.: US 2003/0177081 A1
(43) Pub. Date: Sep. 18, 2003

(54) Method and system for selling to accounts using TOC

(76) Inventor: William A. Woehr, Valencia (ES)

Correspondence Address: BIRCH STEWART KOLASCH & BIRCH, PO BOX 747, FALLS CHURCH, VA, 22040-0747, US

(21) Appl. No.: 10/158,863

(22) Filed: Jun. 3, 2002

Related U.S. Application Data
(60) Provisional application No. 60/364,048, filed on Mar. 15, 2002.

(51) Int. Cl. G06F 17/60

(52) U.S. Cl. 705/36

(57) ABSTRACT

A method for selling to accounts is provided. The method includes analyzing constraints of an account, mapping business opportunities in association with the constraints, generating an opportunity portfolio based on the mapped opportunities, selecting an opportunity to focus from the opportunity portfolio, identifying at least one true constraint of the selected opportunity, removing the true constraint based on a user's decision, and implementing the selected opportunity to increase a throughput of the account.

### RELATED APPLICATION

The present application claims, under 35 U.S.C. §119, the priority benefit of U.S. Provisional Application No. 60/364,048 filed Mar. 15, 2002, entitled “Method and System for Managing Accounts using TOC”, the entire contents of which are herein fully incorporated by reference.

### BACKGROUND OF THE INVENTION

1. Field of the Invention

The present invention relates to a method and system for managing accounts and, more particularly, to a method and system for selling to accounts using the theory of constraints (TOC), wherein the principles of TOC are applied to sales systems to increase sales and profit.

2. Discussion of the Related Art

There are various methods for managing business accounts to increase sales and profit. In this regard, there exist different methods for selling to accounts. “Selling to account(s)” or “account selling” is a term known in the art and it means to win opportunities for business. Two parties are involved in the account selling process and they are: (1) an account managing group who tries to sell accounts and (2) a customer (existing or potential) of the account managing group who will benefit from the account selling. A customer is also referred to herein as the account, but the account technically represents the business of the customer.

Traditional methods for account selling consist of the following steps:

Analyzing the account to find the account's investment budget,

Identifying opportunities to find out how to win opportunities to get share of that investment budget,

“Qualifying in” opportunities to focus on only those opportunities that will be easy to win, and

Making a plan to win the “qualified” opportunities.

In practice, these traditional methods are quite ineffective, because they focus only on opportunities that are easy to win. Opportunities which are difficult to win are “qualified out”, or, in other words, ignored for selling.

Practical data has shown that at least 50% of the business opportunities that exist are “qualified out”—with the effect that a large part of potential business does not get addressed.

Traditional account selling methods may thus mislead top account management to believe that there are a very few opportunities for business selling, while actually there are many opportunities for business selling, which may just not be easy to win, and therefore are “qualified out”. The traditional account selling methods also focus on reducing operating expenses (OE) to increase profit. As a result, they fail to address the true constraints associated with the opportunities and many valuable opportunities that can increase sales and profit are missed.

Thus, there is a great need for an improved account selling technique that effectively increases sales and profit associated with the account.

### SUMMARY OF THE INVENTION

The present invention provides a method, computer program and system for managing accounts using TOC (theory of constraints). More specifically, the present invention applies the principles of TOC to sales systems and businesses to focus on constraints and thereby provide an improved account selling technique.

In accordance with one embodiment, a method for selling to an account, includes analyzing constraints of an account, mapping business opportunities in association with the constraints, generating an opportunity portfolio based on the mapped opportunities, selecting an opportunity to focus from the opportunity portfolio, identifying at least one true constraint of the selected opportunity, removing the true constraint based on a user's decision, and implementing the selected opportunity to increase a throughput of the account.

These and other objects of the present application will become more readily apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention and wherein:

FIG. 1 is a diagram of a system for account selling according to an embodiment of the present invention;

FIG. 2 depicts processing steps of an opportunity engine shown in FIG. 1 according to an embodiment of the present invention;

FIG. 3 is an example of Form #1 usable in a method for account selling according to an embodiment of the present invention;

FIGS. 4A-4C are examples of different Forms #2A, #2B and #2C usable in the method for account selling according to an embodiment of the present invention;

FIG. 4D is an example of a board usable with the forms of FIGS. 4A-4C in the method for account selling according to an embodiment of the present invention;

FIG. 5A is an example of Form #3 usable in the method for account selling according to an embodiment of the present invention;

FIG. 5B is an example of an opportunity portfolio usable in the method for account selling according to an embodiment of the present invention;

FIGS. 6A and 6B are examples of Forms #4A and 4B usable in the method for account selling according to an embodiment of the present invention;

FIG. 7 is an example of Form #5 usable in the method for account selling according to an embodiment of the present invention; and

FIG. 8 is a block diagram of a computer device for practicing the present invention.

### DETAILED DESCRIPTION OF PREFERRED EMBODIMENTS

TOC, as known, provides a systematic methodology that focuses on removing constraints that hinder a business growth. By applying TOC in sales systems, the present invention makes it visible, why the traditional account selling methods struggle to deliver better business results.

The vast majority of constraints for business opportunities with accounts are generated by policies defined by the enterprise and not by market weaknesses. Yet, management often is not aware of these constraints and is therefore not in a position to act on it. The present invention eliminates this weakness by making the constraints for each opportunity visible and by driving the management decisions necessary to remove those constraints. Business then can increase by those opportunities for which the constraints are removed.

In applying TOC to sales systems, the present invention makes the following assumptions:

every system has a goal and a set of necessary conditions that must be satisfied to maximize achievements of the goal;

the sum of the individual system component's optimal solutions is not the system's optimal solution; and

the performance of a system is limited to a very few critical variables (constraints) at a given time, ideally one constraint.

In the present invention, an account may include different ABUs (account business units) such as research, manufacturing, selling, and service divisions in a company. In most cases, the account or ABU will have its own customer(s) who are referred to as “account's customer” or “ABU's customer”. Terms such as an account team, an account manager, or a sales representative (SR) all refer to individuals who are part of the account managing group. The term ‘product’ is intended to cover services, hardware, software, a group of products, or any combination thereof.

To better understand the use of these terms, for the purpose of illustration only, assume a company X (e.g., Gateways) that manufactures a list of products. The company X has a customer Y such as a computer retailer (e.g., Best Buy) who will take the company X's products and sell them to their customers (e.g., consumers, small businesses, etc.). The company X has a group of individuals Z in the company X who oversee or manage Y's business (Y-account) so as to increase the company X's selling to Y. In this example, the group of individuals Z is the account managing group, Y's business is the account (Y-account), and Y's customers are the account's customers. The company X (seller) adopts the system and method of the present invention to sell their business to Y or for Y-account so as to increase the company X's throughput/profit in connection with the Y-account.

A ‘throughput’ (T) is defined herein as the rate at which an organization/company generates money, e.g., through sales of products, and is generally the difference between total revenues and total variable costs measured and assessed.

The present invention provides an improved account managing technique in a broad sense and an improved account selling technique in a narrower sense, usable by an account managing group. The account managing group focuses on constraints using TOC and identifies constraints associated with the account, and possible opportunities (via the products of the account managing group or its company) that can resolve the constraints. The account managing group selects one of the identified opportunities and then identifies the true constraint of the selected opportunity. An account manager or a high-level decision maker of the account managing group then decides whether to resolve the identified constraint of the selected opportunity. If so, then plans are devised to resolve the identified constraint and to implement the selected opportunity. If this is done, the result should be a significantly increased throughput/profit for the company X in connection with the Y-account.

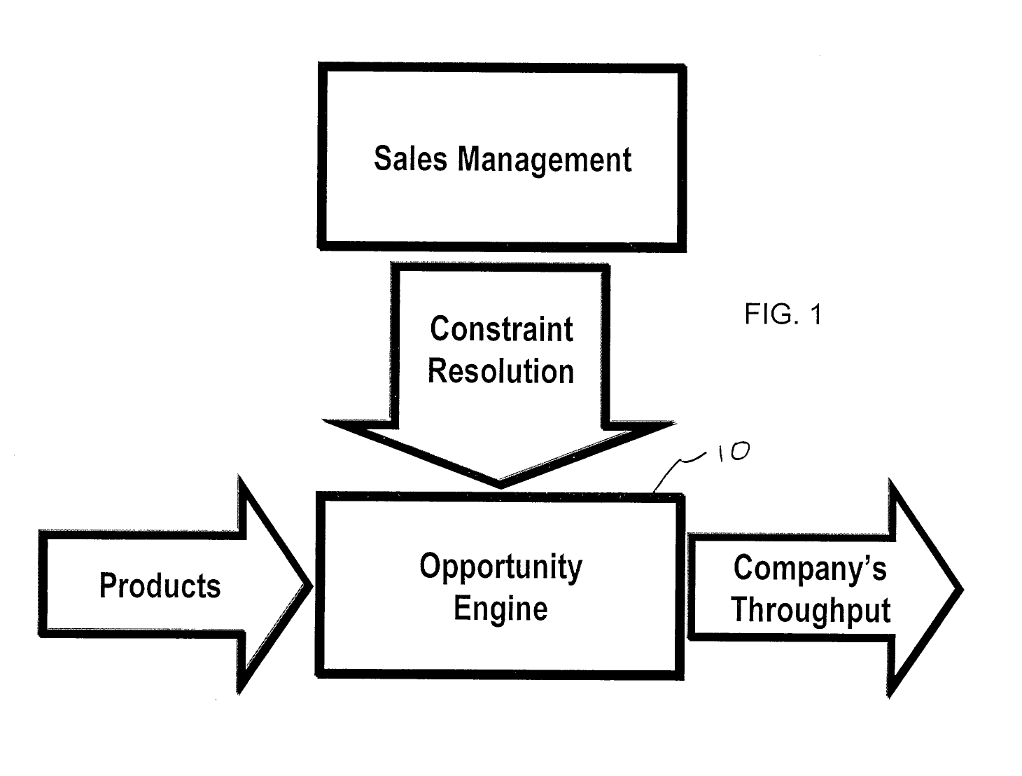

FIG. 1 is a diagram of a system for account selling using TOC focusing on constraints and throughput, instead of reducing operating costs, according to an embodiment of the present invention. As shown in FIG. 1, in the present system, product information and sales-related information such as sales plans, resources and/or rules are processed through what is called an “opportunity engine” 10. The opportunity engine 10 or a part thereof may be implemented manually or by using a computer program. The opportunity engine 10 represents a series of logical steps through which constraints associated with an account are analyzed and an opportunity portfolio (e.g., graph) is generated to identify opportunities with constraints. By reviewing the opportunity portfolio, the opportunities as well as their potential and constraints can be easily understood. One of the opportunities identified in the opportunity portfolio is selected and focused on to identify the true constraint(s) of the selected opportunity. If a decision is made by sales management to resolve the true constraint(s), then plans are formulated to remove the true constraint(s) of the selected opportunity and to implement the selected opportunity, which in turn will increase the throughput of the account.

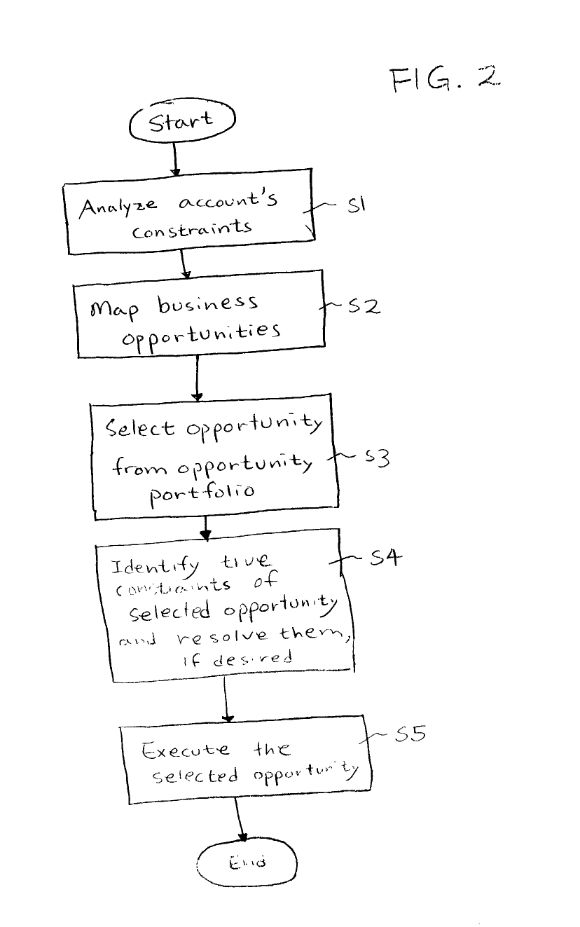

FIG. 2 a flowchart illustrating the logical steps of the opportunity engine 10, these steps being part of a method for selling to accounts according to an embodiment of the present invention. As shown in FIG. 2, Step S1 involves analyzing an account's constraints by a sales representative SR, as seen through the eyes of the account. In the above example, SR is an individual Z and SR's customer is retailer Y. More clearly put, Step S1 involves analyzing the SR's customer's business constraints. Ideally, this step would involve a participation of the SR's customer, but such participation is not required.

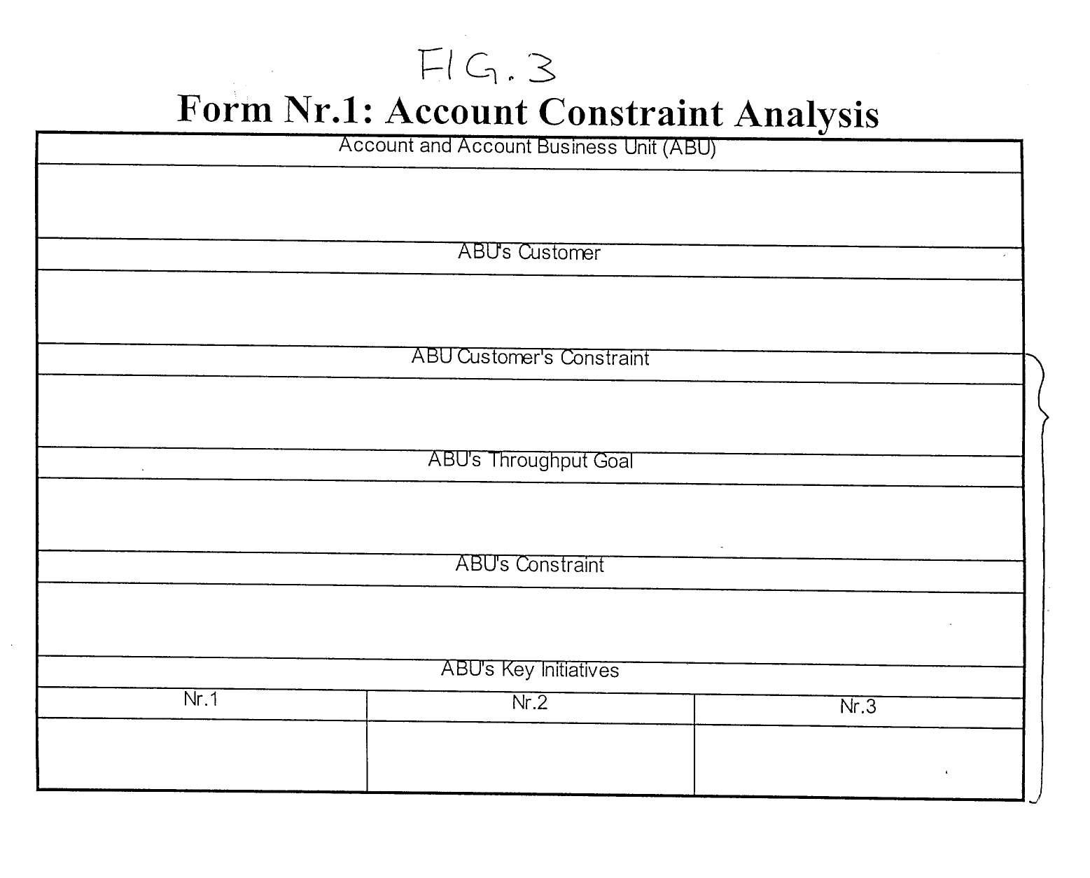

Specifically, Step S1 includes identifying constraints of the account/ABU, constraints of the account/ABU's customer(s)' constraints, the account/ABU's throughput goal, and the account/ABU's key initiatives (i.e., actions that SR's customer is taking to fix the customer's constraints). FIG. 3 is an example of a form (Form #1) which can be used in the account constraint analysis of Step S1 and which lists the categories of items that need to be identified in Step S1 such as account & ABU, ABU's customer, ABU customer's constraint, ABU's throughput goal, ABU's constraint, and Abu's key initiatives. The items of Form #1 are predetermined according to TOC. The SR fills out Form #1 for each ABU or account, ideally with their customer (e.g., retailer Y). In this step and other steps, actions performed by the SR can be performed also by the account team or the like in the account managing group.

Once the constraints associated with the account/ABU have been identified, Step S2 in FIG. 2 is performed. Step S2 involves mapping business/selling opportunities of the SR's company (i.e., company X) by associating the company X's products to each of the key initiatives identified in Form #1 which would help resolve the account's associated constraint. That is, the SR determines which products of the company X can be used to resolve the SR's customer's constraint(s). This is the process of identifying an opportunity (i.e., an opportunity to increase the throughput of the account or company X's business).

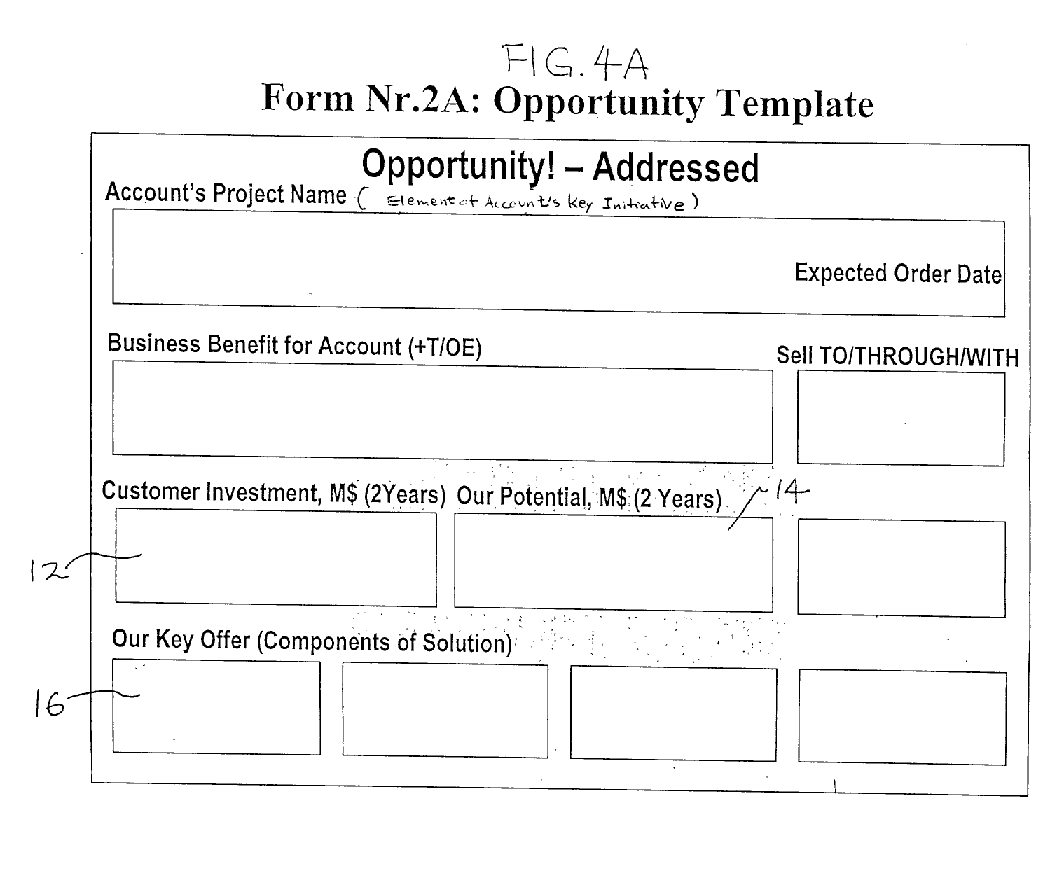

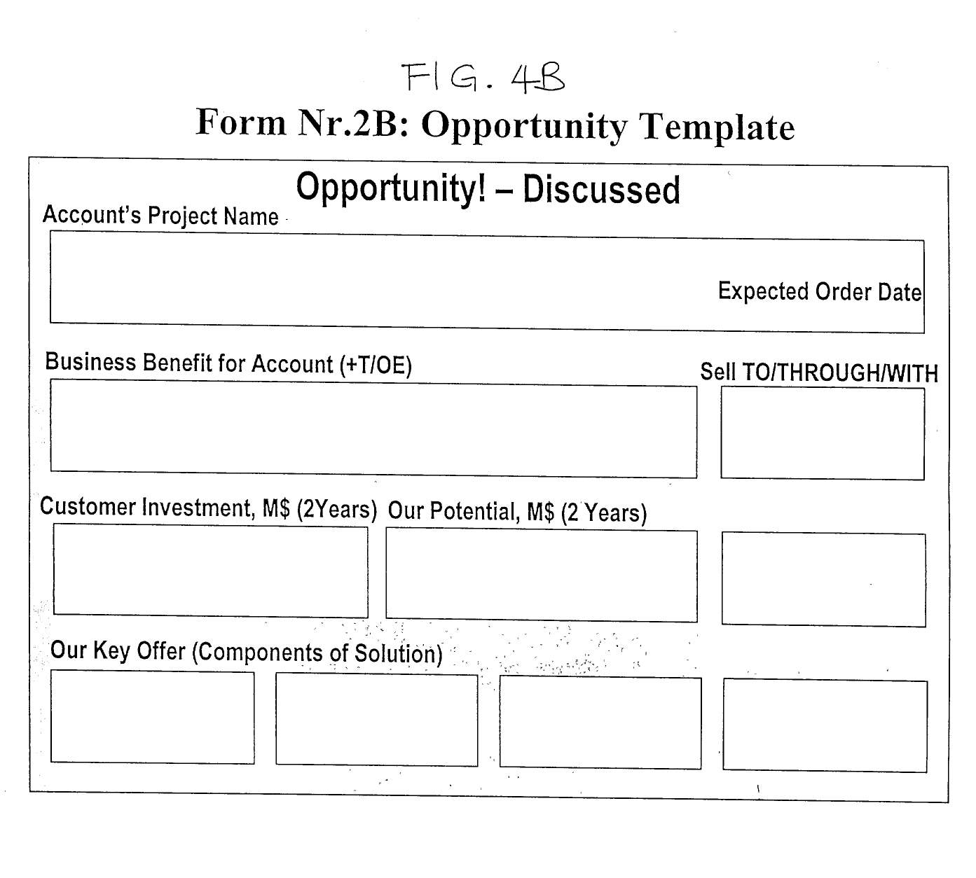

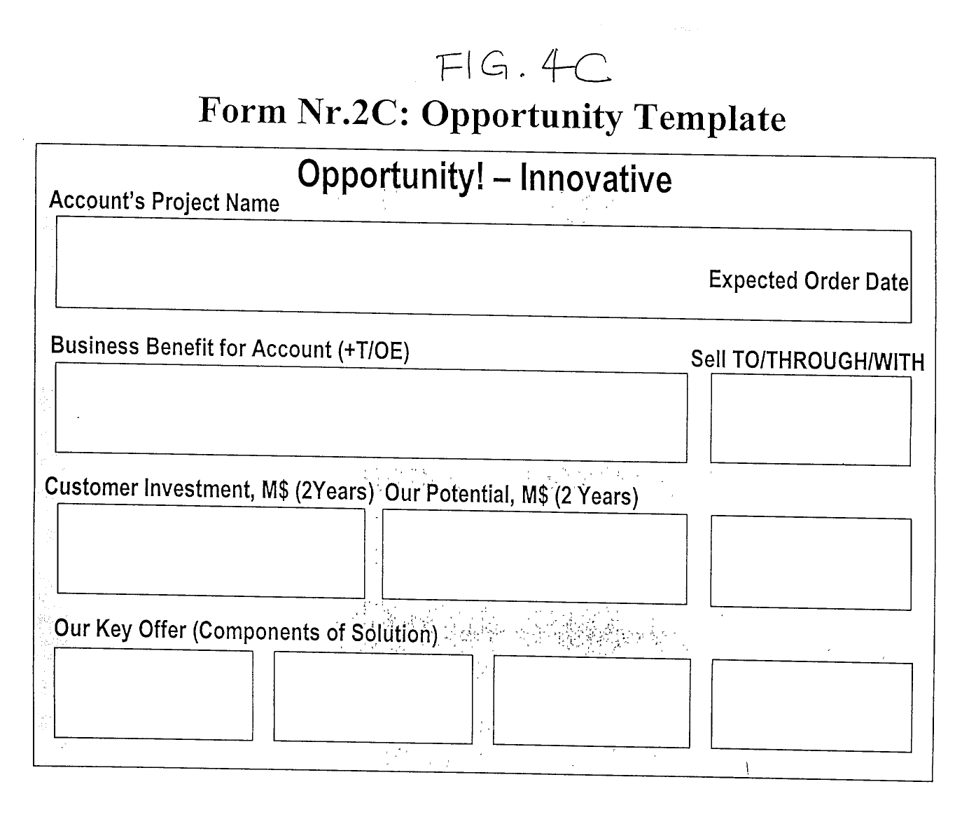

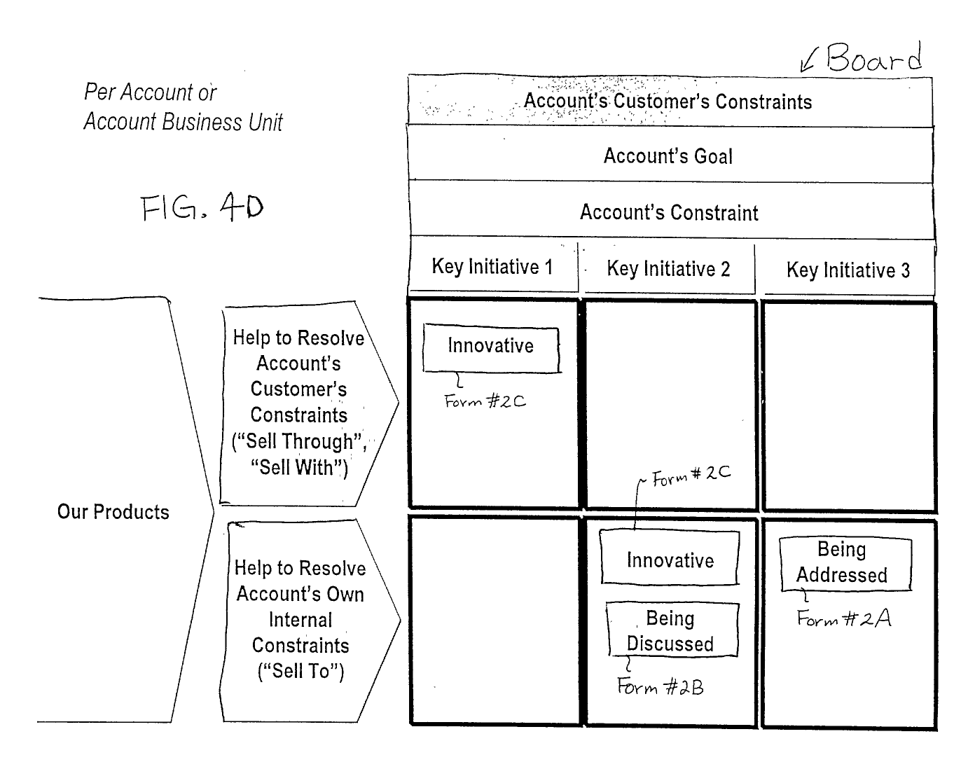

In accordance with one embodiment, various forms (Forms #2A, #2B and #2C) as shown in FIGS. 4A, 4B and 4C are used and filled out by the SR, which may be done with the help of the SR's customer. A board as shown in FIG. 4D is also used where the board corresponds to BI (board information) of Form #1 shown in FIG. 3. An explanation of how the forms and the board in FIGS. 4A-4D may be used in the present invention is now briefly provided.

In accordance with an embodiment, the different opportunities are categorized as ‘Addressed’ (for being addressed), ‘Discussed’ (for being discussed) and ‘Innovative’ (new idea). The Addressed opportunity may be an opportunity (e.g., selling X's certain products) that has been discussed with the SR's customer and is being work on. The Discussed opportunity may be an opportunity that has been initially communicated with the SR's customer. The Innovative opportunity may be an opportunity that has never been presented to the SR's customer. Obviously, other different categories of opportunities can be used to represent the status of each opportunity.

In this example, the three forms (Forms #2A-2C) represent these three different categories of opportunities, respectively, which may be indicated by coloring the forms differently or marking the forms with an appropriate identification. These forms are printed on different color post-its. For each opportunity that the company X has for resolving the account's constraint, this opportunity is mapped to one of the account's key initiatives so as to augment the account's key initiative. This mapping process is accomplished, as shown in FIG. 4D, by posting the appropriate post-its (Forms #2A-2C) in the appropriate boxes of the board that correspond to the key initiatives identified on Form #1. The board in FIG. 4D then easily reveals the entire overview of the company X's opportunities/products that can help resolve the customer's constraints.

Each of Forms #2A-2C as shown in FIGS. 4A-4C requires, among other things, the input of the SR's customer's investment for the corresponding key initiative at Box 12 (FIG. 4A), the company X's potential/involvement at Box 14, and the company X's offers at Box 16 (e.g., solutions to resolve the account's constraint in conjunction with the account's key initiative).

In considering the products/opportunities that would help resolve the account's constraints, both “Sell To” products and “Sell Through” products should be considered as shown in FIG. 4D. A “sell to” product may be a product that the company X sells directly to the retailer/customer Y. A “sell through” product may be a product that can be sold to a company P through the retailer Y. The “Sell To” opportunities help resolve the account's internal constraints, whereas the “Sell Through” opportunities help resolve the account's customer's constraints.

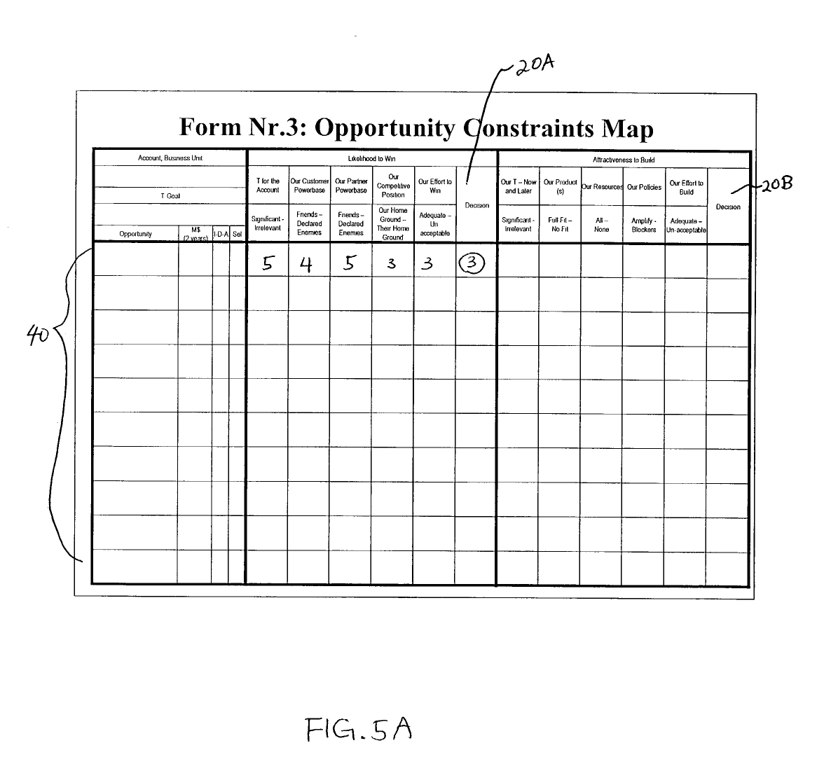

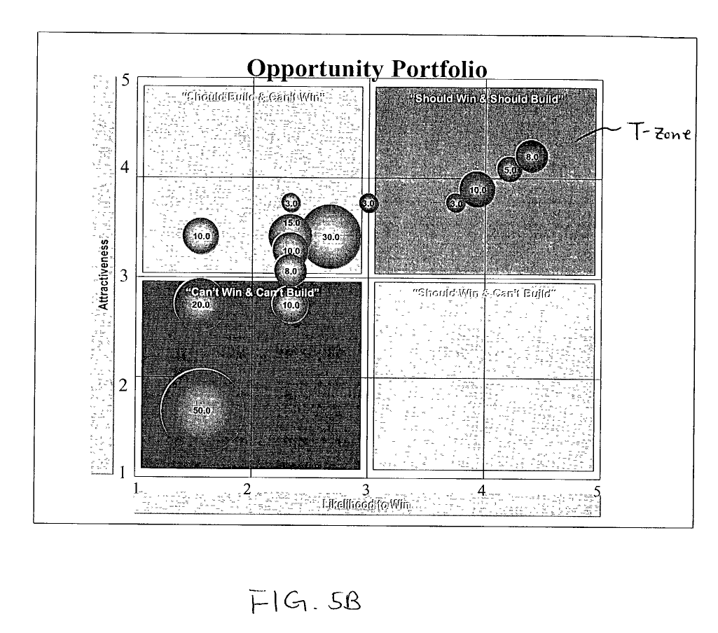

After Step S2, Step S3 is performed in the present method using a form (Form #3) such as one shown in FIG. 5A. In Step S3, the SR scores the different opportunities associated with the account or ABU using Form #3. In this process, the SR lists all the identified opportunities and their related information posted on the board of FIG. 4D per account or ABU at the slots 40 on Form #3. Then the SR scores these opportunities by considering criteria set forth on Form #3. Two main categories of the scoring criteria are considered during the scoring process: Attractiveness and Likelihood. The Attractiveness category examines whether the opportunity is attractive to the SR's company, the seller (i.e., whether it would be profitable for the company X and whether it can be built or implemented by the company X). The Likelihood category examines whether the opportunity is likely to be awarded to the seller (company X), that is, whether the SR's customer will buy from the seller (Company X). The SR fills out Form #3 to score the different opportunities in view of these criteria and any other appropriate criteria that are set. In one example, a score from 1 to 5 can be given to each category on Form #3 where 1 represents the lowest/bad score. Box 20A or 20B labeled “Decision” requires an entry of the lowest score from the row of the scores for each category as shown in FIG. 5A. Obviously, other examples are possible where different scoring methods are used.

Then an opportunity portfolio (map) is automatically generated using a computer program based on the data entered to Form #3. FIG. 5B shows an example of such an opportunity portfolio. All the opportunities associated with the account or ABU can be viewed at one time and clearly understood by viewing the opportunity portfolio. In the portfolio as shown in FIG. 5B, each of the opportunities that have been scored using Form #3 is represented by a circle and is positioned on the Attractiveness and Likelihood axes, units of which corresponding to the lowest score for each category (Boxes 20A and 20B) in Form #3 of FIG. 5A. The diameter of each opportunity circle (which is numerically indicated inside the circle) indicates the size of the potential of the opportunity (i.e., value entered into Box 14 on corresponding Form #2A, #2B or #2C) and the color of each opportunity circle corresponds to the color of Forms #2A-2C which indicates the status of the opportunity.

Then, a decision is made on which opportunity to seize by reviewing the generated opportunity portfolio and any other information analyzed by the SR. This decision is generally made by the account manager, account executive or the like, but may be made by the SR, the customer, or any appropriate entity.

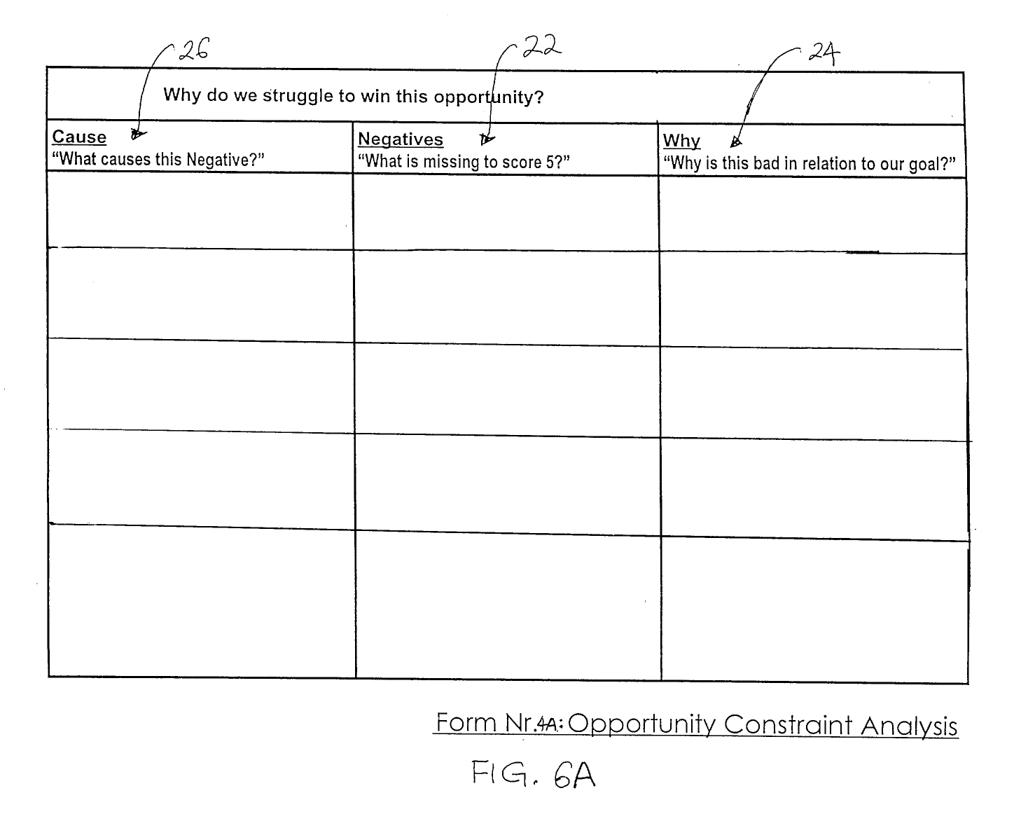

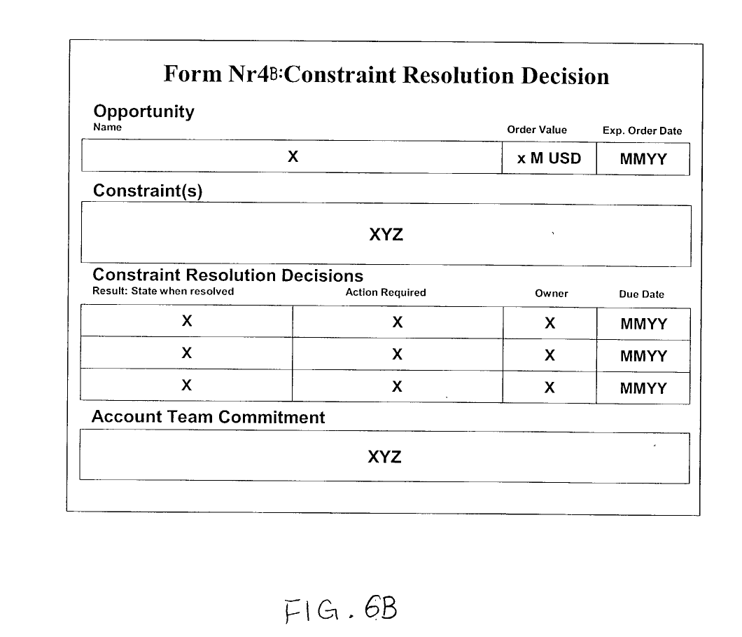

Once the opportunity is selected, then the process focuses on this selected opportunity at Step S4 by analyzing the true constraint(s) of this opportunity using a simple CRT (Current Reality Tree) logic known in the art. In identifying the true constraint(s) of the selected opportunity, three sequential logic steps are taken using a form (Form #4A) such as one shown in FIG. 6A. These steps may be taken by the SR, any member of the account managing group, or any appropriate entity. In one example, in the selected opportunity, for each category that received the score ≦3 on Form #3, it is asked “what is missing to score 5?”. The answer to this question is entered under the “Negatives” column 22 in Form #4A of FIG. 6A. Then, in the next step, one asks “Why is it negative in relation to this opportunity?” The answer to this question is entered under the “Why” column 24 in FIG. 6A. Then in the last step, one asks what is the cause of this negative. The answer to this question is entered under the “Cause” column 26 in FIG. 6A. These steps may be performed by the SR or other entity. Some or all of these sub-steps may be repeated until a true constraint or problem that prevents realization of the selected opportunity is identified through a discussion among the account managing group with or without the customer. Thus, the true constraint(s) of the selected opportunity is revealed.

Once the true constraint of the selected opportunity has been identified, the account manager or any other appropriate entity decides whether to remove this constraint. If yes, then the constraint is removed which shifts the selected opportunity to the T-zone (FIG. 5B) if it is not there already. Form #4B as shown in FIG. 6B is merely an example of a form that can be used to assist the user in this constraint removal decision making process. Obviously, the present invention is not limited to the use of this form and other type forms can be used.

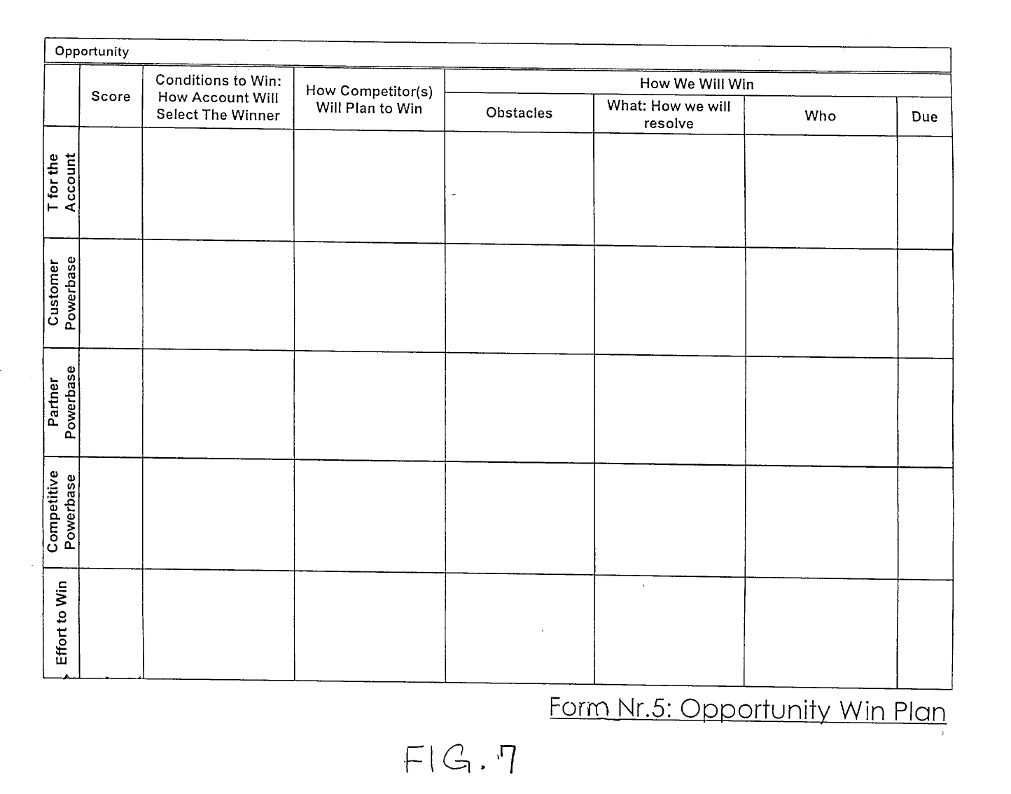

Thereafter, plans are devised to implement the selected opportunity. A form (Form #5) as shown in FIG. 7 may be used to guide the planning process. In Form #5, the vertical-axis categories correspond to the categories under “Likelihood to Win” in Form #3 of FIG. 5A. Obviously, other forms may be used and there may be numerous ways to implement the selected opportunity. Once the selected opportunity is implemented according to the plan, then the throughput of the account will increase.

In accordance with an embodiment of the present invention, at least one of the processing steps S1-S5 shown in FIG. 2 and discussed above is implemented by a computer program. For example, the step of generating an opportunity portfolio can be automatically performed by a computer program as long as certain information is provided. In accordance with the same or another embodiment, the various forms of the present invention are automatically generated by a computer program. These forms can be displayed on a display device such as a monitor or computer screen. In one example, a computer program is provided by which various forms and the board are generated and displayed on a display device and sequentially processed as discussed above in response to inputs by a user such as an SR, account manager, account team, SR's customer, etc.

In another embodiment, Steps S1-S5 can be implemented in part by using the paper forms (e.g., Forms #1-5 printed on paper). However, most enterprises may not be able to resolve the issues of traditional account selling by doing so because: (1) accounts are distributed over different geographies (states, countries, regions); (2) accounts have different business units, each of them needing to be addressed for business opportunities (manufacturing, logistics, research and development, finance, etc.); (3) the information for all steps of account selling and for all opportunities may need to be kept up to date electronically since changes may occur much faster than a paper-based system can handle; and (4) the opportunity data must be read across accounts and business units, for instance by product sales managers who must understand the constraints for their products across accounts. To address these concerns, the electronic forms and compilation programs may be used to implement the present invention as discussed above.

In one example, the computer program can provide various screen displays that help the user to step through the processing steps S1-S5 of FIG. 2. These displays can include pop-up windows or any other graphical/audio tools to guide the user in entering the needed information to run the present method. The user makes any entry to the forms directly into a computer using a user input device such as a keyboard, handheld pen, etc. In the alternative, the user may make the entry to the forms by writing on the forms by hand. The entries made into the computer can be processed and compiled by the computer according to the computer program to implement Steps S1-S5, given that the user interaction is provided.

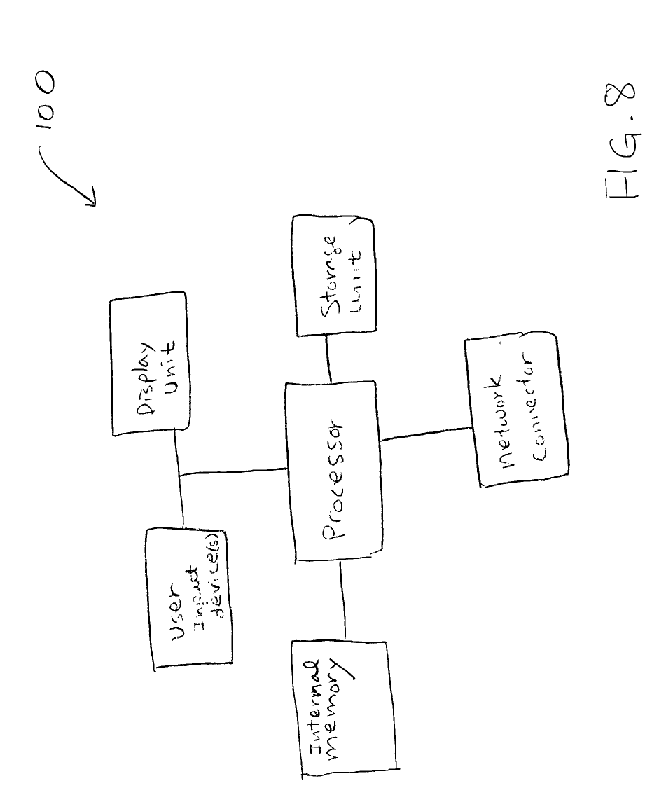

The computer program(s) discussed above can be written in any computer programming language known in the art, and are part of the present invention. Although the specific codes of the computer program(s) are not disclosed, one skilled in the computer art would readily appreciate that there are a variety of different ways to implement the above discussed steps of the present method in a computer program, and all such variations are intended to be covered by the present invention. The embodiments of the present invention can be implemented using existing hardware and/or software, such as a computer. An example of a block diagram of a computer usable in the present invention is shown in FIG. 8. As shown in FIG. 8, the computer 100 may include known elements such as a processor, storage unit(s), user input device(s) such as a keyboard or mouse, a display unit such as a monitor, network or internet connection devices, etc. The storage unit may be, for example, a hard disk, floppy disc, optical disc, internal memory, and/or any other known storage unit.

In sum, the present invention adjusts the traditional account selling process in view of TOC methodology, and, inter alia, adds a new, innovative technique (Step S4 in FIG. 2) to the traditional approach. In adjusting the traditional account selling process in view of TOC methodology:

When analyzing the account (Step S1 in FIG. 2), the present invention focuses the sales efforts on studying the account's constraints, (the traditional process focuses on those areas where the account plans to invest);

When finding opportunities (Step S2 in FIG. 2), the present invention focuses on aligning account's constraints to own offers (traditional focus is again on account's investment plans);

When viewing an opportunity portfolio (Step S3 in FIG. 2), the present invention redefines the portfolio so that constraints become visible; and

When building an opportunity win plan (Step SS in FIG. 2), the present invention structures this plan to focus on the key attributes of opportunity constraints and on overcoming the constraints to win.

In Step S4 of FIG. 2, for the selected opportunity, the constraints are analyzed, the decisions to remove these constraints are made, each of these decisions is assigned to an appropriate party who will execute them, and each of the decisions and execution is tracked. As a consequence of Step S4, opportunities which traditionally would have been “qualified out” are now addressable by the removal of their constraints, the sales opportunity volume increases significantly, and business for the user(s) will increase.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for selling to an account, the method comprising the steps of:
analyzing constraints of an account;
mapping business opportunities in association with the constraints; and
generating an opportunity portfolio based on the mapped opportunities.

2. The method of claim 1, further comprising the step of:
selecting an opportunity to focus from the opportunity portfolio.

3. The method of claim 2, further comprising the step of:
identifying at least one true constraint of the selected opportunity.

4. The method of claim 3, further comprising the steps of:
removing the true constraint based on a user's decision; and
implementing the selected opportunity to increase a throughput of the account.

5. The method of claim 4, wherein at least one of the steps is guided by a computer program.

6. The method of claim 4, wherein at least one of the steps is implemented according to a computer program.

7. The method of claim 1, further comprising the step of:
providing a plurality of different forms to be filled in at least one of the steps.

8. The method of claim 7, wherein the forms are paper forms, electronic forms, or a mix of the paper and electronic forms.

9. The method of claim 7, wherein the forms are predefined according to theory of constraints.

10. The method of claim 1, wherein the opportunity portfolio is a graph depicting at least one of the following:
status of each of different opportunities associated with the account;
financial information pertaining to each of the opportunities; and
attractiveness and likelihood information associated with each of the opportunities.

11. A computer program product embodied on a computer-readable medium, for guiding an account selling process, the computer program product comprising computer executable instructions for:
analyzing constraints of an account;
mapping business opportunities in association with the constraints; and
generating an opportunity portfolio based on the mapped opportunities.

12. The computer program product of claim 11, further comprising computer executable instructions for:
selecting an opportunity from the opportunity portfolio based on certain predefined criteria.

13. The computer program product of claim 12, further comprising computer executable instructions for:
identifying at least one true constraint of the selected opportunity based on user input.

14. The computer program product of claim 13, further comprising computer executable instructions for:
formulating a plan to remove the true constraint based on certain criteria.

15. The computer program product of claim 14, further comprising computer executable instructions for:
formulating a plan to execute the selected opportunity, so as to increase a throughput of the account.

16. The computer program product of claim 11, further comprising computer executable instructions for:
generating a plurality of different forms to be filled in, the forms being used in analyzing the constraints of the account, mapping business opportunities, and/or generating the opportunity portfolio.

17. The computer program product of claim 16, wherein the forms are paper forms, electronic forms, or a mix of the paper and electronic forms.

18. The computer program product of claim 16, wherein the forms are generated according to theory of constraints.

19. The computer program product of claim 11, wherein the opportunity portfolio is a graph depicting at least one of the following:
status of each of different opportunities associated with the account;
financial information pertaining to each of the opportunities; and
attractiveness and likelihood information associated with each of the opportunities.
